(19) United States
(12) Patent Application Publication
(10) Pub. No.: US 2012/0318150 A1
(43) Pub. Date: Dec. 20, 2012

(54) Pancake Wrapper

(76) Inventors: Sanjaya S. Vajapey, Indianapolis, IN (US); Chaya S. Bangalore, Indianapolis, IN (US)

(21) Appl. No.: 13/405,278

(22) Filed: May 7, 2012

Related U.S. Application Data
(60) Provisional application No. 61/464,187, filed on Mar. 1, 2011.

(51) Int. Cl. A47J 43/00

(52) U.S. Cl. 99/450.6

(57) ABSTRACT

This device is a small kitchen tool to easily put fillings in pancakes or other flat pan dishes and to easily enhance the presentation of the dish in various shaped rolls.

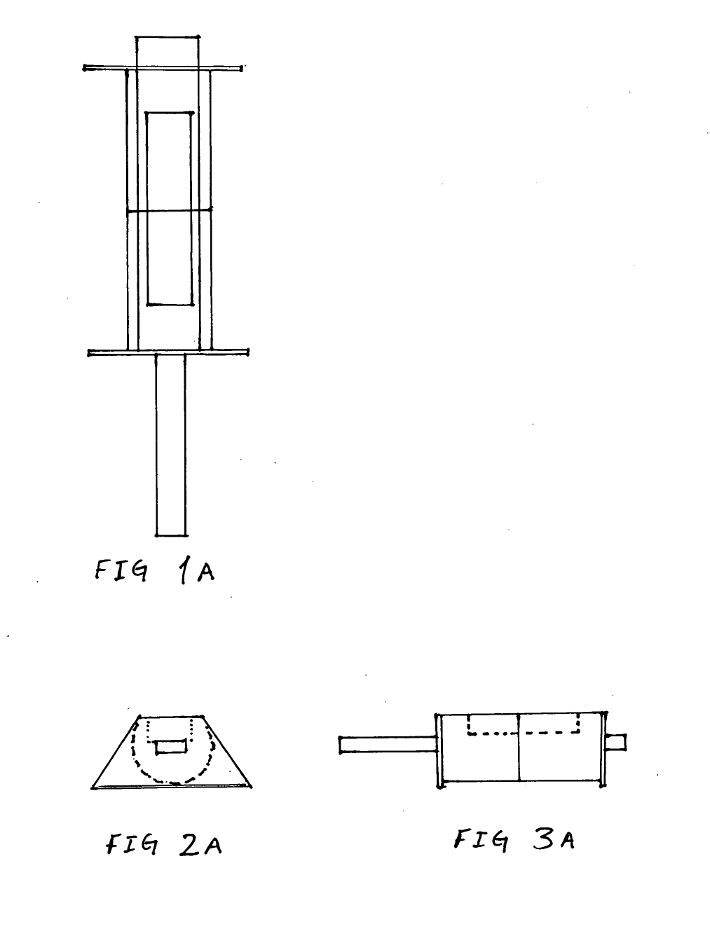

FIG. 1A in the drawings can be used to represent the overall invention in the summary or synopsis of this invention.

### CROSS-REFERENCE TO RELATED APPLICATIONS

This Non-Provisional application has reference to the Provisional application No. 61/464187 that is dated Mar. 1, 2011 with Confirmation No 9621.

### BACKGROUND OF THE INVENTION

The Pancake Wrapper is a small kitchen device useful for wrapping and rolling flat pan dishes like Pancakes, Omelets, Crepes, Tacos, Burritos, Masala Dosas (or Masala Doses) etc into rolls of different shapes. In fact, the Pancake Wrapper can be used to wrap and roll on a flat pan, all dishes made of liquid batter, semi solid batter, semi solid dough. The Pancake Wrapper can also fill the above dishes with savory fillings while enhancing the presentation of the dishes for color, roast, crust, crispiness, texture and even sponginess. This invention can be used in homes, restaurants, fast food joints, eateries etc.

### BRIEF SUMMARY OF THE INVENTION

The dimensions of the Pancake Wrapper, in the real world, are approximately 41.6 cm (length in plan) by 13.2 cm (width in plan) and by 5.9 cm (height in elevation). It is a device made of metal with plastic handles. The device consists of two (2) parts connected by a latch mechanism. The two parts equally share a common hollow space between them to hold savory fillings. One part has the long handle and the other has a short one. The Pancake Wrapper rests on two (2) flat bases located at either end.

### BRIEF DESCRIPTION OF THE SEVERAL VIEWS OF THE DRAWING

5 pages of drawing were mailed to the USPTO earlier.

### DRAWING DESCRIPTIONS

FIG. 1A: This is the plan of the whole invention. It has a length of approximately 41.6 cm. It has a hollow space at the top of approximately 16 cm in length. It has 2 parts that can be pulled apart with a latch mechanism by pressing a button. The hollow space is split equally between the 2 parts. The bottom part with the long handle is approximately 27.4 cm and is represented by FIG. 1B. The top part with the short handle is approximately 22.5 cm (inclusive of the part that latches) and is represented by FIG. 1C.

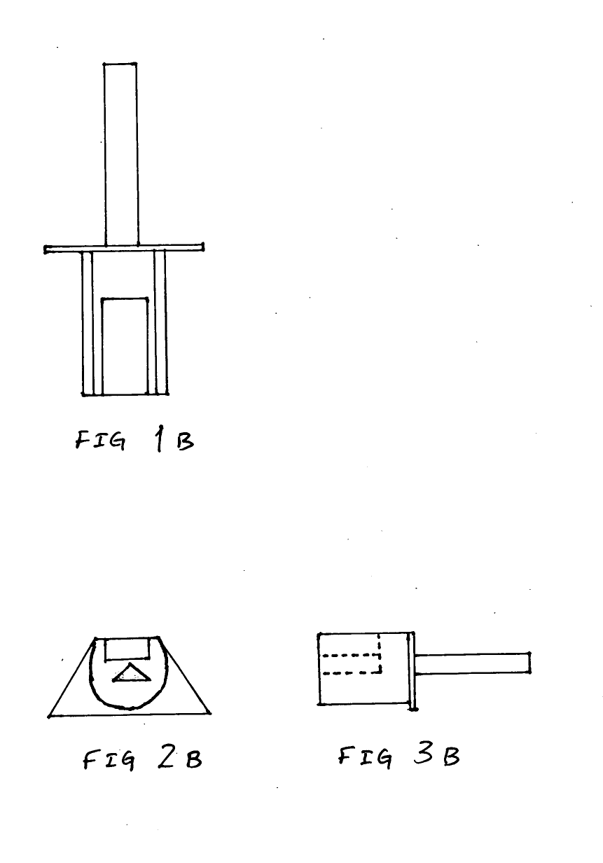

FIG. 2A: This is the elevation of FIG. 1A with a ‘part’ circle cross section.

FIG. 3A: This is the perspective of FIG. 1A from a 60 degree angle.

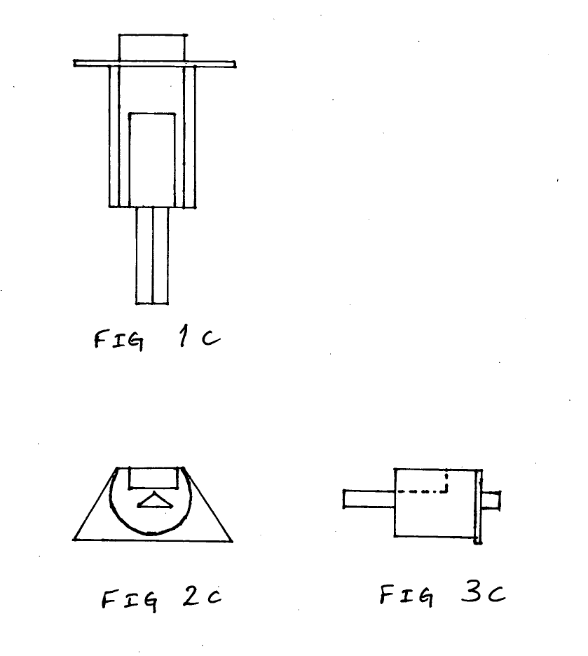

FIG. 4A: This is an alternate elevation of FIG. 1A with a square cross section.

FIG. 5A: This is another alternate elevation of FIG. 1A with a triangle cross section.

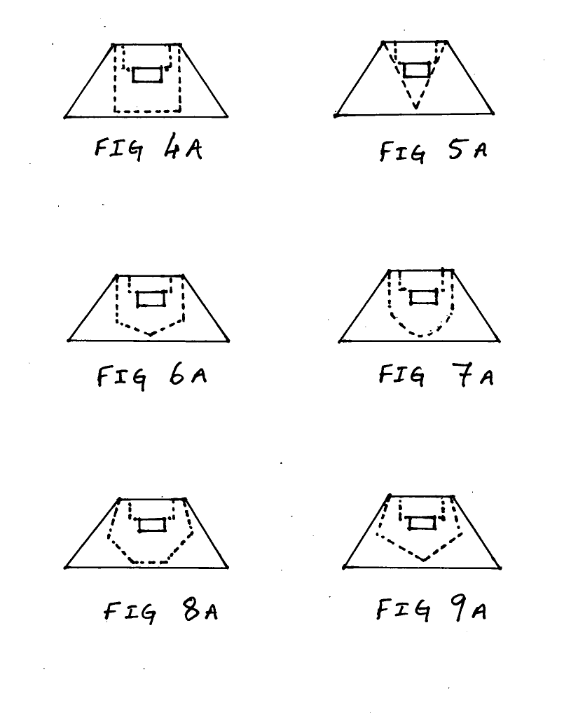

FIG. 6A: This is another alternate elevation of FIG. 1A with a cross section having 5 sides.

FIG. 7A: This is another alternate elevation of FIG. 1A with a cross section having 3 sides and a curved portion.

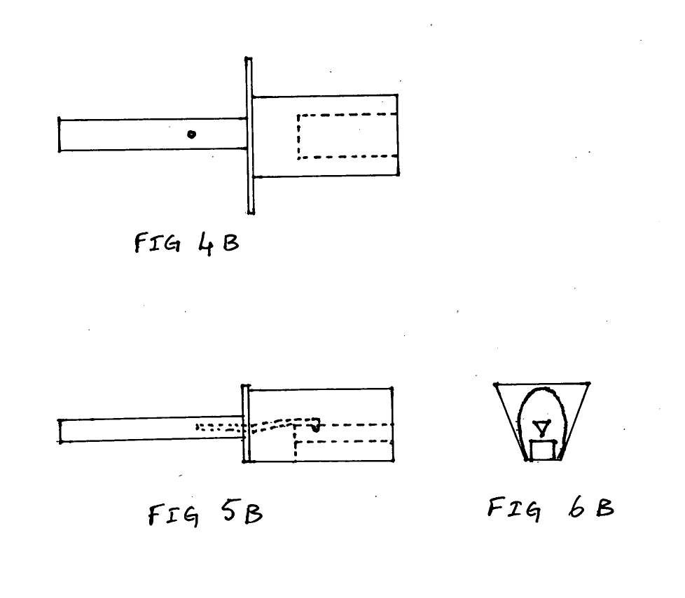

FIG. 8A: This is another alternate elevation of FIG. 1A with a cross section having 6 sides.

FIG. 9A: This is another alternate elevation of FIG. 1A with a cross section having 5 sides.

FIG. 1B: This is the plan of the part with the long handle. Its length is approximately 27.4 cm. It has half of the full hollow space.

FIG. 2B: This is the elevation of FIG. 1B. The triangle in the center represents the hole for the latch mechanism.

FIG. 3B: This is the perspective of FIG. 1B from a 60 degree angle.

FIG. 4B: This is the plan of underside of the part in FIG. 1B. The handle shows the location of a proposed button to operate the latch mechanism. By pressing this button, the 2 parts (FIG. 1B and FIG. 1C) can be pulled apart.

FIG. 5B: This is the elevation of FIG. 4B showing the proposed latch mechanism.

FIG. 6B: This is the perspective of FIG. 4B from a 60 degree angle.

FIG. 1C: This is the plan of the part with the short handle shown at the top. It has half of the full hollow space. It is approximately 22.5 cm in length inclusive of the part that latches. The bottom portion is the latching part with a triangular cross section that can slide into the triangular hole shown in FIG. 2B.

FIG. 2C: This is the elevation of FIG. 1C. The triangle in the center represents the cross section of the latching part.

FIG. 3C: This is the perspective of FIG. 1C from a 60 degree angle.

### SPECIFICATION

### Detailed Description of the Invention

The dimensions of the Pancake Wrapper are approximately 41.6 cm (length in plan) by 13.2 cm (width in plan) and by 5.9 cm (height in elevation). It is a device made of metal with plastic handles. The device consists of two parts connected by a latch mechanism. The top of the Pancake Wrapper has a hollow space with a flat rim to hold the savory fillings.

After the flat pan dish is done, the Pancake Wrapper is placed at the center of the dish and the fillings are put in the hollow space.

Using a spatula, the flat pan dish is fully wrapped around the filling filled “hollow” of the Pancake Wrapper so that the dish is formed into a ‘Roll’ on the flat pan.

Using the spatula again, the entire Pancake Wrapper along with the dish is lifted and inverted over onto a plate.

At the press of a button, the two halves of the Pancake Wrapper are pulled apart freely and easily so that the fillings remain right in the center of the dish.

The end result is that the dish is “Easily” filled with appropriate fillings and beautifully “Commercial” presented for Color, Roast, Crust, Crispiness, Texture and Sponginess wherever appropriate while also presenting the dish in various shaped Rolls as illustrated in the diagrams.

1: We, the inventors, claim that the Pancake Wrapper is the only invention in the world today that can be used to wrap and roll flat pan dishes like Pancakes, Omelets, Crepes, Tacos, Burritos, Masala Dosas (or Masala Doses) or any flat pan flat dish into rolls of different “cross sectional” shapes while also easily putting fillings inside those dishes.

2: We, the inventors, claim that the Pancake Wrapper is the only invention in the world today to present flat pan dishes like Pancakes, Omelets, Crepes, Tacos, Burritos, Masala Dosas (or Masala Doses) or any flat pan flat dish as rolls showing maximum color or maximum roast or maximum crust or maximum crispiness or maximum texture or even maximum sponginess.
